(19) United States
(12) Patent Application Publication
(10) Pub. No.: US 2005/0147244 A1
(43) Pub. Date: Jul. 7, 2005

(54) Method for cryptographic transformation of binary data blocks

(76) Inventors: Alexander Moldovyan, Leningradskaya Reg. (RU); Nikolai Moldovyan, Leningradskaya Reg. (RU)

Correspondence Address: YOUNG & THOMPSON, 745 SOUTH 23RD STREET, 2ND FLOOR, ARLINGTON, VA, 22202, US

(21) Appl. No.: 10/747,135

(22) Filed: Dec. 30, 2003

(51) Int. Cl. H04L 9/28

(52) U.S. Cl. 380/29; 380/37

(57) ABSTRACT

A method for cryptographic transformation of a binary data block comprising the steps splitting said data block into N≧2 sub-blocks, alternately converting said sub-blocks by the operations implemented with a controlled substitution-permutation network (CSPN), and performing a controlled CSPN-based involution on at least the i-th sub-block, where i=1, 2, . . . , N. A ciphering/deciphering device is also provided.

The present invention relates to the field of communications and computer technology and, more particularly, to the field of cryptographic methods and devices for encryption of messages (information).

Prior Art

In describing features of the claimed method the following terms are used:
secret key is binary information known only to the legitimate owner;
cryptographic transformation is digital data transformation which allows the influence of a source data bit on a plurality of output data bits, for example, for the purpose of protecting information from unauthorized reading, generating digital signature, and generating modification detection code. Some important types of cryptographic transformations are unilateral transformation, hashing, and encryption;
information hashing is a certain method of forming a so-called hash-code of a fixed size (typically 128, 160, 256 bits) for messages of any size; hashing methods are widely used that are based on iterative hash functions using block mechanisms of information cryptographic transformation (see Lai X., Massey J. L. Hash Functions Based on Block Ciphers/Workshop on the Theory and Applications of Cryptographic Techniques. EUROCRYPT'92, Hungary, May 24-28, 1992, Proceedings, p. 53-66);
encryption is an information transformation process which depends on the secret key and which transforms a source text into a cipher text representing a pseudo-random character sequence from which obtaining information without the knowledge of the secret key is practically unfeasible;
decryption is a process which is the reverse of encryption; decryption ensures recovering information according to the cryptogram when the secret key is known;
cipher is a totality of elementary steps of input data transformation using the secret key; the cipher may be implemented in the form of a computer program or as a separate device;
binary vector is a certain sequence of off-bits and on-bits, such as 1011010011; a specific structure of the binary vector may be interpreted as a binary number if it is assumed that the position of each bit corresponds to a binary bit, i.e. the binary vector may be compared with a numerical value which is unequivocally determined by the binary vector structure;
cryptanalysis is a method of calculating the secret key for obtaining unauthorized access to ciphered information or developing a method which provides access to the ciphered information without calculating the secret key;
cryptographic security represents work effort measured in the number of elementary operations to be performed in order to recover information according to a cryptogram when the transformation algorithm is known, but without the knowledge of the secret key; in the case of unilateral transformation, by cryptographic resistance is meant complexity of calculating of the input block value according to its output value;
controlled operation F_{n/m}(X), where X is the input binary vector to be transformed, is an operation that represents a set of fixed operations called modifications F_{V}, which are selected depending on some binary vector called controlling vector; the output of the controlled operation is Y=F_{V}(X); furthermore the notation Y=F_{n/m}^{(V)}(X) is used, where F_{n/m}^{(V)} denotes the modification F_{V};
controlled operations F_{n/m} and F⁻¹_{n/m} are (called) referred to as mutually inverse, for all fixed values of the vector V when the respective modifications F_{V} and F⁻¹_{V} are mutually inverse; F_{n/m} is (called) referred to as a direct controlled operation and F⁻¹_{n/m} is (called) referred to as a inverse controlled operation; furthermore F⁻¹_{n/m} is (called) referred to as mutual inverse of F_{n/m};
controlled substitution-permutation network (CSPN) is a network consisting of two or more cascades of controlled substitution boxes called controlled elements (CE), the cascades being connected with simple wiring (fixed permutations). The CSPN is used, for example, to implement (perform) the controlled operations on data sub-blocks while ciphering;
permutation network is a particular type of CSPN, implementing a controlled bit permutation operation;
CSPN is used to implement controlled operations of different types, for example, controlled involutions;
operations implemented with CSPN are called the CSPN-based operations;
data-dependent operation is a controlled operation that depends on the data to be converted;
data-dependent rotation is a cyclic shift operation in which the shift value depends on transformed data sub-blocks; operations of cyclic shift to the left (right) are designated with the sign “<<<” (“>>>”), for example, the notation B₁<<<B₂ signifies an operation of cyclic shift to the left of sub-block B₁ on the number of bits equal to the value of binary vector B₂; similar operations are basic for the RC5 cipher;
data-dependent permutation is a bit permutation operation performed on some binary vector depending on transformed data;
involution is an operation that is inverse to itself; let, for example, F be an involution, then we have F=F⁻¹, where F⁻¹ and F are mutual inverses;
permutational involution is a bit permutation operation that (is) satisfies the criteria for an involution.

Methods of data block encryption are known, e.g., US standard DES (National Bureau of Standards. Data Encryption Standard. Federal Information Processing Standards Publication 46, January 1977). This method of data block encryption comprises generating a secret key, splitting the data block being converted into two sub-blocks L and R and alternately changing the latter by carrying out a bitwise modulo 2 addition operation between the sub-block L and a binary vector which is generated as an output value of a certain function F according to the value of sub-block R: L←F(R), where “←” denotes an assignment operation. Thereupon the blocks are swapped. In this method, function F is implemented by performing transposition and stuffing operations on sub-block R This method has a high transformation rate when realized in the form of specialized electronic circuitry. A demerit of the DES encryption method is the use of a short 56-bit secret key that makes DES vulnerable to attacks based on trying all keys to find one that fits, which needs massive computer power and modern supercomputers.

Another known method is implemented in the cipher RC5 and disclosed in the work (R. Rivest, The RC5 Encryption Algorithm/Fast Software Encryption, second International Workshop Proceedings (Leuven, Belgium, Dec. 14-16, 1994), Lecture Notes in Computer Science, v.1008, Springer-Verlag, 1995, pp. 86-96). This method comprises generating a secret key in the form of a totality of sub-keys, splitting an input data block into sub-blocks A and B, and alternate sub-block transformation. The sub-blocks are transformed by in turn performing
1) modulo 2ⁿ addition operations, where n=8, 16, 32, 64;
2) bitwise modulo 2 addition operations, and
3) data-dependent rotation operations.

A sub-block, for example sub-block B, is converted as follows: A modulo 2 bit-for-bit summing operation (“⊕”) is performed on sub-blocks A and B and the value obtained following this operation is assigned to sub-block B. This is written as a relation:
B<B⊕A,
where the sign “←” signifies the assignment operation. Thereafter, the operation of cyclic shift on the number of bits equal to the value of sub-block A is performed on sub-block B:
B←B<<<A.

Then the modulo 2ⁿ summing operation is performed on the sub-block and one of sub keys S: B←(B+S) mod 2ⁿ, where n is the sub-block length in bits. After this, sub-block A is converted in a similar way. Several such transformation steps are performed for both sub-blocks.

This method provides a high encryption rate when implemented in the form of a computer program or in the form of electronic ciphering devices. However, the RC cipher uses comparatively complex key scheduling that makes the RC5 slow when keys are changed frequently.

Another method for cryptographic transformation of binary data blocks is iterative block encryption, disclosed in the Russian patent_{—}2141729, published in Bulletin of Russian Patents no 32 on Nov. 20, 1999, by Moldovian et al. with the title: “Method of iterative block encryption of discrete data”. The prototype method comprises the following features:
forming the encryption key as a set of round sub-keys;
splitting input 64-bits of data in two 32-bits sub-blocks-words-L and -R;
multi-round transformation of these words performing one data-dependent permutation operation on them.

The prototype method comprises splitting a data block into N≧2 sub-blocks, alternately converting the sub-blocks by performing at least one controlled permutation operation on the i-th sub-block, where i≦N, said operation depending on the value of the j-th sub-block, where j≦N. Characteristic of this method is the use of the data dependent permutations. Due to use of the data dependent permutation operations that method provides high security against the known attacks. However, it has some disadvantages related to the need to use different electronic schemes to perform encryption and decryption.

### SUMMARY OF THE INVENTION

Hence there is a need for a new method of cryptographic transformation of binary data blocks, allowing transformation of input data using the same algorithm and/or the same electronic circuit for both encryption and decryption.

The object of the invention is to provide a method that overcomes the drawbacks of the prior art methods of cryptographic transformation and electronic ciphering devices. This is achieved by the method of cryptographic transformation as defined in claim 1, the ciphering device as defined in claim 9, and the deciphering device as defined in claim 10.

The object is achieved by a method of cryptographic transformation of a binary data block, comprising the steps of splitting said data block into N≧2 sub-blocks, alternately converting said sub-blocks by operations implemented with a controlled substitution-permutation network (CSPN), and performing a controlled CSPN-based involution on at least the i-th sub-block, where i=1, 2, . . . , N.

In a preferred embodiment the i-th sub-block, where i=1, 2, . . . , N, is transformed with the controlled CSPN-based involution, which is a substitutional involution.

In another preferred embodiment the i-th sub-block, where i=1, 2, . . . , N, is transformed with the controlled CSPN-based involution which is a permutational involution.

In another preferred embodiment N=2 and the first sub-block is converted with a direct controlled CSPN-based operation depending on the second sub-block. Then the second sub-block is converted with the controlled CSPN-based involution depending on the first sub-block. Then the first sub-block is converted with the inverse controlled CSPN-based operation on the second sub-block.

In another preferred embodiment N=2 and the first and second sub-blocks are transformed simultaneously by performing on the first sub-block the direct controlled CSPN-based operation depending on the second sub-block and by performing on the second sub-block the controlled CSPN-based involution depending on the second sub-block, and then the first sub-block is converted with the inverse controlled CSPN-based operation depending on the second sub-block.

The object can also be achieved by a ciphering/deciphering device arranged to perform the above method of cryptographic transformation.

One advantage of such a method or device is that the same algorithm/device can be used to perform encryption and decryption, i.e., the same electronic circuit can be used for enciphering and deciphering.

Another advantage is that the hardware implementation cost of the disclosed method is significantly reduced.

Embodiments of the invention are defined in the dependent claims. Other objects, advantages, and novel features of the invention will become apparent from the following detailed description of the invention when considered in conjunction with the accompanying drawings and claims.

### BRIEF DESCRIPTION OF THE DRAWINGS

FIG. 1 is a generalized diagram of cryptographic transformation according to the claimed method.

FIG. 2 schematically shows the structure of a controlled substitution-permutation network (CSPN) used as a controlled operational box.

FIG. 3 represents the general notation of the controlled element and two main types of the controlled elements used as building blocks while constructing the CSPN.

FIG. 4 shows the general structure of the controlled CSPN-based operational box F_{n/m} (a) and its notation (b)

FIG. 5 shows the controlled operational boxes R_{8/12}, R⁻¹_{8/2}, R⁻¹_{32/96}, and R⁻¹_{32/96}

FIG. 6 shows the structure of the F*_{2n/m}, R*_{64/96}, and S*_{64/96} controlled CSPN-based involutions implemented with CSPN.

FIG. 7 shows the structure of the two mutually inverse controlled CSPN-based operational boxes R_{64/192} and R⁻¹_{64/192}.

FIG. 8 shows a scheme of the encryption transformation implementing the disclosed method corresponding to examples 2 and 3 of the invention formula.

FIG. 9 shows a scheme of the encryption transformation implementing the declared method corresponding to example 4 of the invention formula.

FIG. 10 shows a scheme of the encryption transformation implementing the declared method corresponding to example 5 of the invention formula.

FIG. 11 shows a number of different examples of controlled elements.

### DETAILED DESCRIPTION OF THE INVENTION

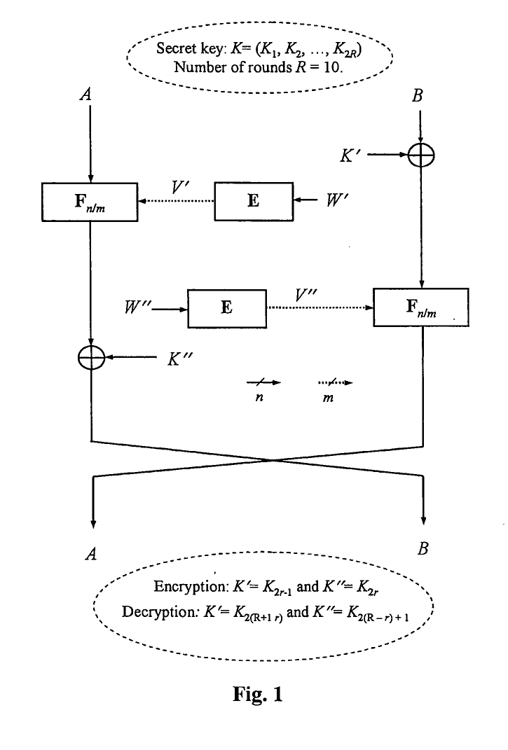

The invention is explained with a generalized diagram of data block transformation based on the claimed method shown in FIG. 1, where: F*_{n/m} is the controlled CSPN-based involution, i.e., the F*_{n/m} box represents a controlled substitution-permutation network performing an involution operation; E is the extension box implemented as simple connections; A and B are converted n-bit sub-blocks, i.e., n is the data sub-block length in bits; K₂ᵣ, K₂ᵣ₋₁ are n-bit secret key elements (n-bit sub-keys), where r=1, 2, . . . , R and R is the number of the last round; V′ and V″ are the controlling vectors, i.e. binary vectors generated depending on input data; m is the bit length of the controlling vector; the ⊕ symbol signifies the bitwise modulo 2 addition operation. Bold solid lines designate the n-bit signal transmission bus. Dotted lines signify controlling vectors and controlling bits. Using the sub-key bits as control signals ensures forming a specific modification of sub-block bit transposition operation dependent on the value of an input block that additionally enhances resistance of cryptographic transformation.

FIG. 1 shows one round of transformations. Depending on a specific implementation of the controlled transposition block and the required transformation performance, from 2 to 12 and more rounds may be set. This scheme of cryptographic transformation procedures may be used to perform encryption and one-way transformations. In the latter case, the secret key is not used, and instead of sub-key signals, the control input of the F_{n/m} boxes implemented with CSPN is fed with signals of the binary vector V′ and V″ generated depending on the value of the current value of both sub-blocks. When ciphering, the controlling vector is generated depending on 1) one of the n-bit sub-keys and on only one sub-block or 2) one of the sub-blocks. Namely, if the current controlled CSPN-based involution is performed on the sub-block A, then the controlling vector is generated depending on the sub-block B and sub-key K₂ᵣ₋₁, i.e. V′=V′(W′), where W′=B⊕K₂ᵣ₋₁. If the current controlled CSPN-based involution is performed on the sub-block B, then the controlling vector is generated depending on the sub-block A and sub-key K₂ᵣ₋₁, i.e. V″=V″(W″), where W″=A⊕K₂ᵣ and r denotes the number of the current round. When the typical sub-block size is n=64, the secret key length is 128R bits. In each round two sub-keys are used. For example, when the round number is R=3, the first round uses sub-keys K₁ and K₂, the second round uses sub-keys K₃ and K₄, the third round uses sub-keys K₅ and K₆.

The possibility of technical implementation of the claimed method is explained with its following specific embodiments.

### EXAMPLE 1

This example describes the algorithm of the one-way transformation that can be used to construct iterative hash functions:
1. Set value z=1.
2. Generate controlling vector V′:
   W′=A⊕B and V′=E(W′).
3. Convert sub-block A according to expression:
   A←F*_{n/m}^{(V′)} (A), where upper index ^{(V′)} denotes dependence on V′ (i.e. index ^{(V′)} means that binary vector V′ is used as the controlling vector while performing the F*_{n/m} controlled CSPN-based involution).
4. Generate controlling vector V″ depending on the values V′, A and B according to formulas:
   W″=A⊕B and V″=V′⊕E(W″).
5. Convert sub-block B according to expression:
   B←F*_{n/m}^{(V″)} (B), where upper index ^{(V″)} denotes dependence on V″.
6. If z=0, then go to step 8.
7. Swap sub-blocks A and B, set the value z=0 and go to step 2.
8. STOP.

This general method of cryptographic transformation of binary data blocks can be incorporated in any suitable ciphering/deciphering method. Example 2 shows one preferred ciphering/deciphering method comprising the cryptographic transformation according to the present invention.

### EXAMPLE 2

Example 2 uses a secret key represented as the set of the following sub-keys: K₁, K₂, . . . , Kₜ, where t is an even number, e.g. 20. This example (see FIG. 1) describes encryption algorithm implementing the declared method:
1. Set the counter r=1.
2. Convert sub-block B according to the expression:
   B←B⊕K₂ᵣ₋₁.
3. Generate controlling vector V′ performing the following calculations:
   W′=K₂ᵣ₋₁⊕B;
   V′=E(W′).
4. Transform the sub-block A with the box F*_{n/m}:
   A←F*_{n/m}^{(V′)}(A).
5. Generate controlling vector V″ depending on the sub-block A and sub-key K₂ᵣ in accordance with the following formulas:
   W″=A⊕K₂ᵣ;
   V″=E(W″).
6. Convert sub-block B according to expression:
   B←F*_{n/m}^{(V″)}(B).
7. Convert sub-block A according to expression:
   A←A⊕K₂ᵣ₋₁.
8. Swap sub-blocks A and B.
9. If r=t/2, then go to step 11.
10. Increment r←r+1 and go to step 2.
11. STOP.

The respective decryption algorithm is the following one:
1. Set the counter r=1.
2. Convert sub-block B according to expression:
   B←B⊕K₍ₜ₊₂₎₋₂ᵣ.
3. Generate controlling vector V′ performing the following calculations:
   W′=K₍ₜ₊₂₎₋₂ᵣ⊕B;
   V′=E(W′).
4. Transform the sub-block A with the box F*_{n/m}:
   A←F*_{n/m}^{(V′)}(A).
5. Generate controlling vector V″ depending on the sub-block A and sub-key K₍ₜ₊₂₎₋ᵣ in accordance with the following formulas:
   W″=A⊕K₍ₜ₊₁₎₋ᵣ;
   V″=E(W″).
6. Convert sub-block B according to expression:
   B←F*_{n/m}^{(V″)}(B).
7. Convert sub-block A according to expression:
   A←A⊕K₍ₜ₊₁₎₋ᵣ.
8. Swap sub-blocks A and B.
9. If r=(t/2), then go to step 11.
10. Increment r←r+1 and go to step 2.
11. STOP.

One can see that the same algorithm performs both the data encryption and the data decryption using two different variants of the key scheduling.

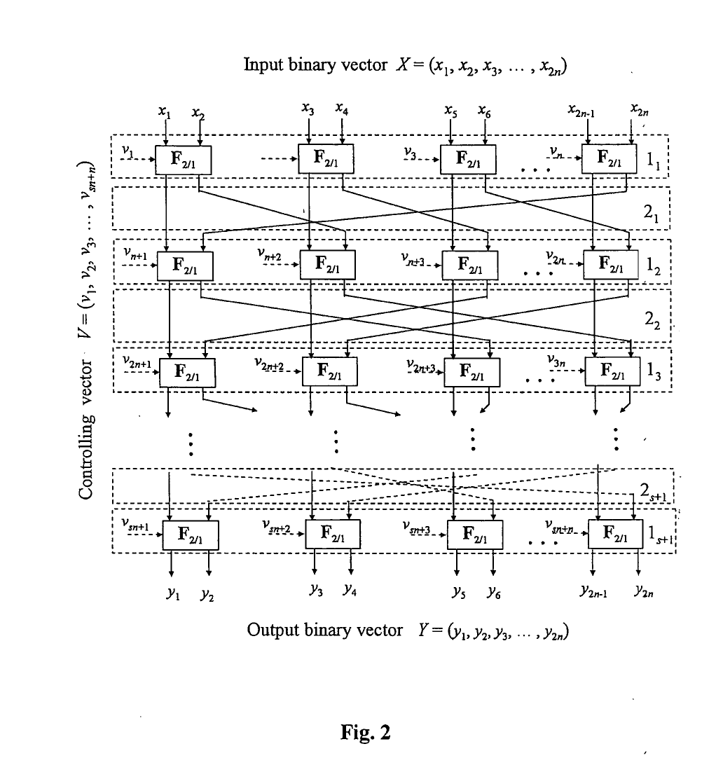

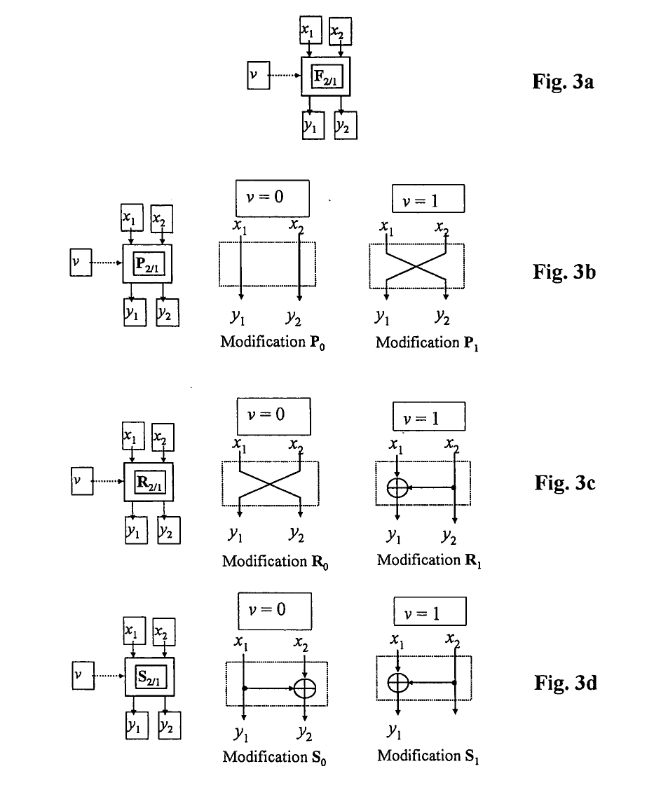

FIG. 2 shows a possible embodiment of the controlled network with a cascade structure using the totality of elementary controlled boxes F_{2/1} called controlled elements. The elementary controlled boxes F_{2/1} are arranged in a number of the active cascades separated with fixed connections called fixed permutations. The active cascades are denoted by positions 1₁, 1₂, . . . , 1ₛ₊₁. The fixed permutations are denoted by positions 2₁, 2₂, . . . , 2ₛ. Such a controlled network is used to perform controlled operations called operational substitutions. This embodiment corresponds to the operational box F_{n/m}, where n is the length of the input and output binary vectors X=(x₁, x₂, x₃, . . . x₂ₙ) and Y=(y₁, y₂, y₃, . . . , y₂ₙ), correspondingly, m is the length of the controlling vector V=(v₁, v₂, v₃, . . . , vₛₙ₊ₙ), m=sn and s is the number of active cascades in the controlled network. Control signals are designated with dotted lines similar to the designation in FIG. 1. Each controlled element F_{2/1} (see FIG. 3) is controlled with one controlling bit vᵢ and implements two variants of the transformation of the two-bit binary vector called modification F₀ (for vᵢ=0) and modification F₁ (for vᵢ=1). The modification F₀ is described by a pair of simple functions y′₁=f′₁(x₁,x₂) and y′₂=f′₂(x₁,x₂), where x₁ and x₂ are input bits of the controlled element and y₁ and y₂ are output bits of the controlled element. The modification F₁ is described by a pair of simple Boolean functions in two variables: y₁″=f₁″(x₁,x₂) and y₂″=f₂″(x₁,x₂). Depending on selection of the type of functions f′₁(x₁,x₂), f′₂(x₁,x₂), f₁″(x₁,x₂), and f₂″(x₁,x₂) one can assign different properties of the controlled operational substitution. Selecting special types of functions f′₁,f′₂, f₁″ and f₂″ for example y′₁=f′(x₁,x₂)=x₁, and y′₂=f′(x₁,x₂)=x₂, y′₁=f′(x₁,x₂)=x₂, and y′₂=f′(x₁,x₂)=x₁, one can define the controlled permutation of two bits x₁ and x₂. Three examples of possible types of the controlled elements F_{2/1} (FIG. 3a): 1) controlled element P_{2/1} that represents a controlled switching element called also controlled permutation element, 2) controlled element R_{2/1}, and 3) controlled element S_{2/1}, are shown in FIGS. 3b, 3c, and 3d respectively. The controlled element P_{2/1} implements modifications P₀ and P₁, where P₀ is described by functions y₁=x₁ and y₂=x₂ and P₁ is described by functions y₁=x₂ and y₂=x₁. The controlled element P_{2/1} implements an elementary controlled permutation(s) and we get a controlled permutation network if the controlled element P_{2/1} is used as standard building block.

The controlled elements R_{2/1} and S_{2/1} represent two different variants of controlled substitution elements. When using the controlled substitution elements we get a substitution permutation network, the type of which depends on the type of the substitution elements used as main building blocks. The controlled element R_{2/1} implements modifications R₀ and R₁, where R₀ can be described by functions y₁=x₂ and y₂=x₁ and R₁ can be described by functions y₁=x₁⊕x₂ and y₂=x₂. The controlled element S_{2/1} can implement modifications S₀ and S₁, where S₀ is described by functions y₁=x₁ and y₂=x₁⊕x₂ and S₁ is described by functions y₁=x₁⊕x₂ and y₂=x₂. Other possible variants of the modifications P₀, P₁, S₀, S₁, R₀, and R₁ are presented in Table 1 that describes a second variant of the controlled elements P_{2/1}, R_{2/1}, and S_{2/1}.

TABLE 1

| P_{2/1} | | R_{2/1} | | S_{2/1} | |
|---|---|---|---|---|---|
| P₀ | P₁ | R₀ | R₁ | S₀ | S₁ |
| y₁ = x₁ | y₁ = x₂ | y₁ = x₂ ⊕ 1 | y₁ = x₁ ⊕ x₂ | y₁ = x₁ ⊕ x₂ ⊕ 1 | y₁ = x₁ |
| y₂ = x₂ | y₂ = x₁ | y₂ = x₁ ⊕ 1 | y₂ = x₂ | y₂ = x₂ | y₂ = x₁ ⊕ x₂ ⊕ 1 |

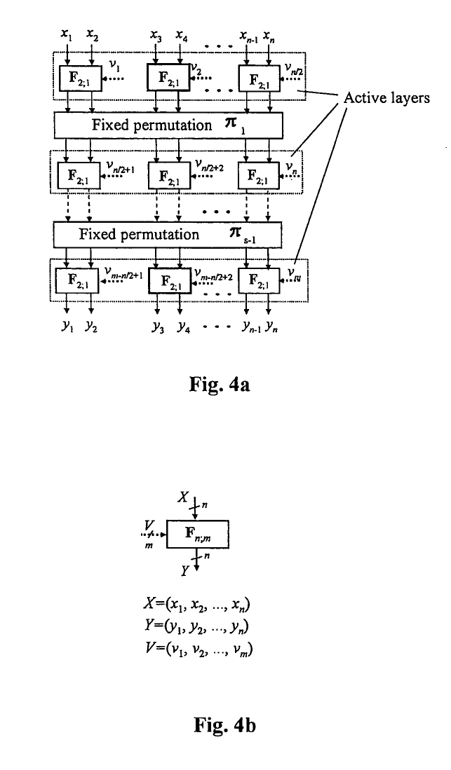

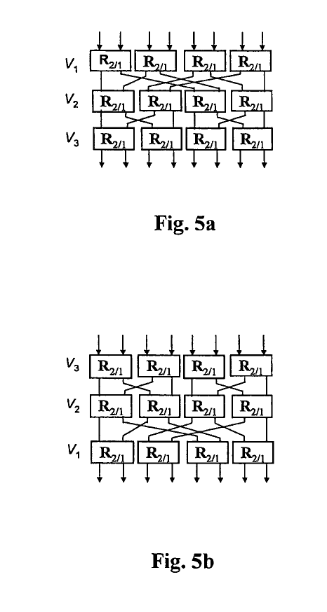

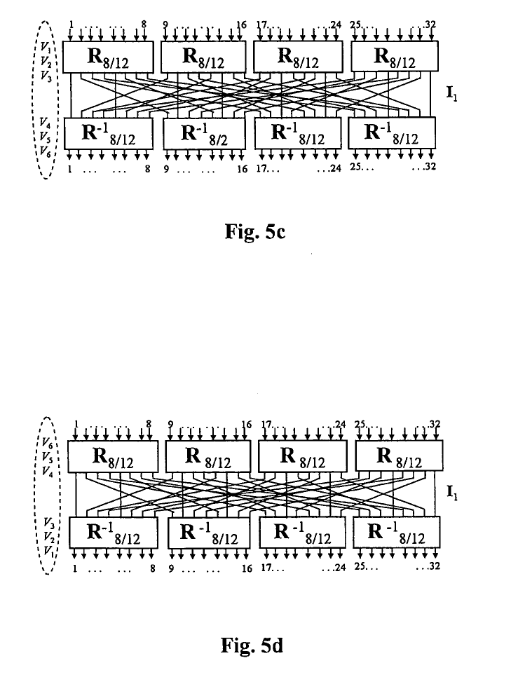

For the fixed controlling vector V the box F_{n/m} implements some modification denoted as F_{V}. The number of different modifications implemented by some box F_{n/m} equals 2^{m}. FIGS. 4a,b shows a general representation of the controlled operational box F_{n/m} with distribution of the controlled bits (a) and general designation of the controlled operational box F_{n/m} (b). FIGS. 5a-d show important variants of the design of the controlled operational boxes R_{8/12} (a), R⁻¹_{8/12} (b), R_{32/96} (c), and R⁻¹_{32/96} (d), respectively, where F⁻¹_{n/m} designates mutual inverse of F_{n/m}. Two controlled operations F_{n,m} and F⁻¹_{n/m} are called mutually inverse if for all fixed values of the vector V the respective modifications F_{V} and F⁻¹_{V} are mutually inverse.

FIGS. 5c and 5d show the structure of the mutually inverse controlled operational substitutions R_{32/96} and R⁻¹_{32/96} that are composed as a two-cascade structure. The upper cascade comprises four operational boxes R_{8/12} and the lower cascade comprises four operational boxes R⁻¹_{8/12}. The cascades are separated by a fixed permutational involution I₁, described as follows:
(1)(2,9)(3,17)(4,25)(5)(6,13)(7,21)(8,29)(10)
(11,18,12,26)(14)(15,22)(16,30)(19)(20,27)(23)(24,31)(28)(32).
   Connections implementing the fixed involution I₁ are shown in FIGS. 5a-d. Due to the symmetric structure of the boxes R_{32/96} (c) and R⁻¹_{32/96} (d) they differ only by different distribution of the controlling bits. Actually, the boxes R_{32/96} and R⁻¹_{32/96} represent a six-layer substitution-permutation network with the mirror symmetry topology, in which four boxes R_{8/12} and four boxes R⁻¹_{8/12} are structurally picked out. In the direct box R_{32/96} the 32-bit component Vᵢ of the controlling vector V=(V₁, V₂, V₃, V₄, V₅, V₆) controls the i-th active layer for i=1, 2, . . . , 6. In the inverse box R⁻¹_{32/96} the 32-bit component Vᵢ of the controlling vector V=(V₁, V₂, V₃, V₄, V₅, V₆) controls the (7-i)-th active layer for i=1, 2, . . . , 6. In both boxes, the direct one and inverse one of the active layers are numbered from top to bottom. By replacing the controlled elements R_{2/1} by the controlled elements P_{2/1} and/or S_{2/1} one can easily construct the following pairs of the mutually inverse boxes: 1) P_{32/96} (c) and P⁻¹_{32/96} and 2) S_{32/96} and S⁻¹_{32/96}. Using different types of the controlled elements S_{2/1} one can construct different variants of the mutual inverse boxes S_{32/96} (c) and S⁻¹_{32/96}. Using different types of the controlled elements R_{2/1} one can construct different variants of the mutual inverse boxes R_{32/96} (c) and R⁻¹_{32/96}.

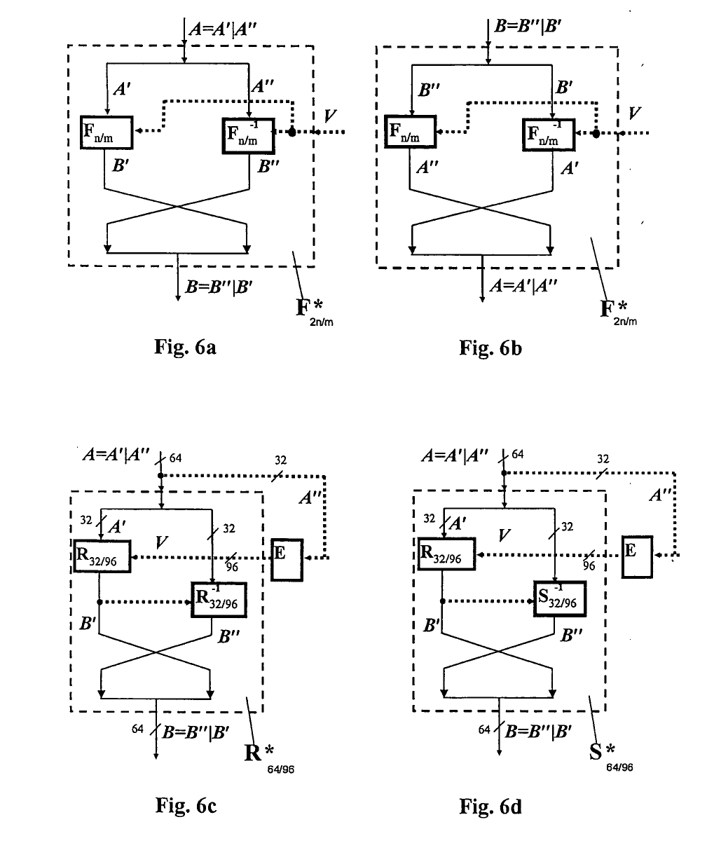

FIG. 6a,b shows the design of the controlled CSPN-based involution F*_{2n/m} implemented with two mutually inverse boxes F_{n/m} and F⁻¹_{n/m}. This design topology allows simple construction of the following controlled CSPN-based involution: 1) P*_{64/96} by use of the boxes P_{32/96} and P⁻¹_{32/96}; 2) R*_{64/96} by use of the boxes R_{32/96} and R⁻¹_{32/96}; 3) S*_{64/96} with the use of the boxes S_{32/96} and S⁻¹_{32,96}. FIG. 6a shows the transformation of the binary vector A=A′/A″ represented as concatenation of two binary vectors A′ and A″ with the F*_{2n/m} controlled CSPN-based involution: B=F*_{2n/m} (A), where B is the transformed vector. FIG. 6b demonstrates that the operation performed with box F*_{2n/m} is an involution, since for an arbitrary fixed controlling vector we have:
F*_{2n/m}(B)=F*_{2n/m}(F*_{2n/m}(A))=A.
FIG. 6c shows the design of a R*_{64/96} controlled CSPN-based involution. FIG. 6d shows the design of a S*_{64/96} controlled CSPN-based involution. In these controlled CSPN-based involutions, the 96-bit controlling vector is formed as depending on one of the halves of the input data sub-block (denoted as A″). Another feature is the additional internal controlling vector controlling the part of CSPN performing the transformation of the A″ binary vector. The last feature defines the operations R*_{64/96} and S*_{64/96} implemented with CSPN as involutions.

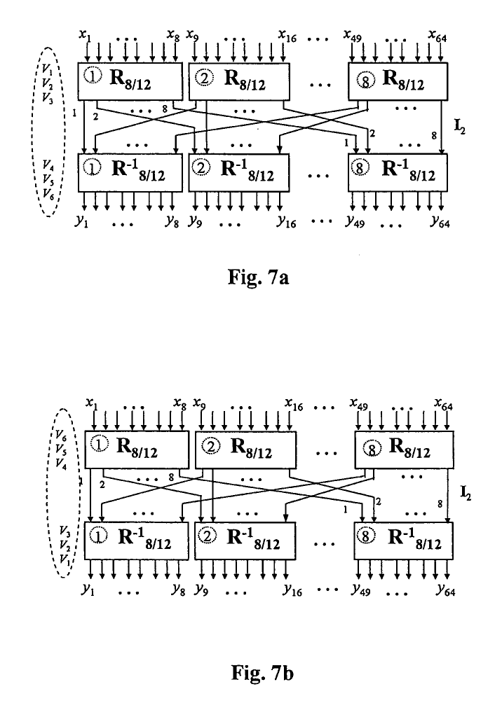

In order to make the encryption more secure one can combine the controlled CSPN-based involutions with two mutually inverse operations conserving the possibility to perform encryption and decryption with the same algorithm. FIGS. 7a,b show the structure of the mutually inverse controlled operational substitutions R_{64/192} and R⁻¹_{64/192} that are composed as two-cascade structures. The upper cascade comprises eight operational boxes R_{8/12} and the lower cascade comprises eight operational boxes R⁻¹_{8/12}. The cascades are separated with fixed permutational involution I₂, described as follows:
(1)(2,9,3,17,4,25,5,33,6,41,7,49,8,57)(10) (11,18,12,26,13,34,14,42,15,50,16,58)(19)(20,27,21,35,22,43,23,51,24,59)
(28)(29,36,30,44,31,52,32,60)(37) (38,45,39,53,40,61)(46)(47,54,48,62)(55)(56,63)(64).
   The fixed permutational involution I₂ is implemented as fixed connections of outputs of the upper cascades with inputs of the lower cascade. The connections provided for each box R_{8/12} are connected with each box R⁻¹_{8/12}. In the direct box R_{64/192} the 32-bit component V₁ of the controlling vector V=(V₁, V₂, V₃, V₄, V₅, V₆) controls the i-th active layer for i=1, 2, . . . , 6. In the inverse box R⁻¹_{64/192} the 32-bit component Vᵢ of the controlling vector V=(V₁, V₂, V₃, V₄, V₅, V₆) controls the (7-i)-th active layer for i=1, 2, . . . , 6. In both boxes the direct one and inverse one of the active layers are numbered from top to bottom.

Due to the simple structure of the operational boxes performing the controlled CSPN-based involutions, the modern planar technology of manufacturing integrated circuits allows efficient production of cryptographic microprocessors comprising controlled boxes performing operational substitutions with any suitable input size such as 32, 64 and 128 bits or more.

### EXAMPLE 3

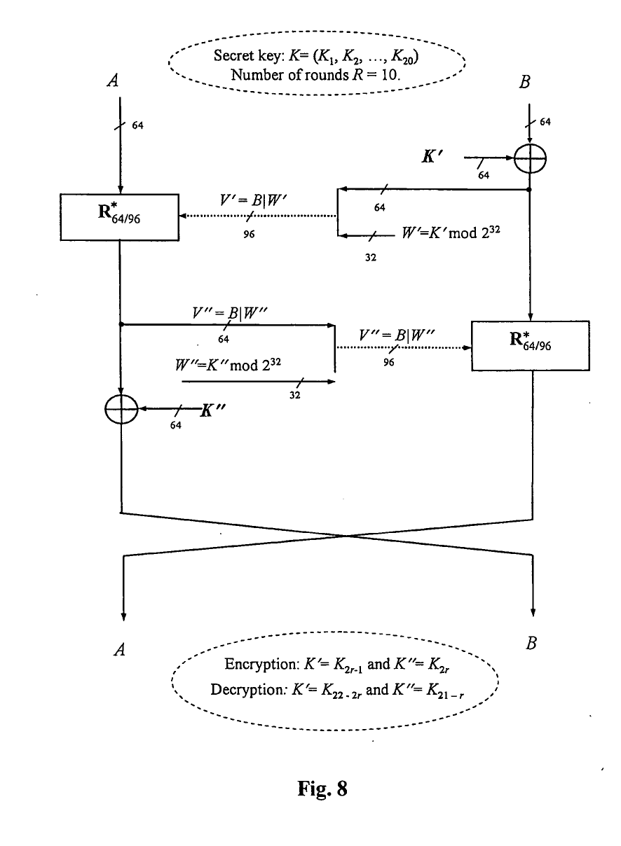

Example 3 uses the secret key represented as the set of the following 64-bit sub-keys: K₁, K₂, . . . , K₂₀. This example is illustrated in FIG. 8. Example 3 describes the following encryption algorithm implementing the declared method:
1. Set the counter r=1.
2. Convert sub-block B according to expression:
   B←B⊕K₂ᵣ₋₁.
3. Generate controlling vector V′ performing calculations:
   W′=K₂ᵣ₋₁mod 2³²;
   V′=B|W′,
   where “|” denotes a concatenation operation.
4. Convert sub-block A according to expression:
   A←R*_{64/96}^{(V′)}(A).
5. Generate controlling vector V″ depending on the sub-block A and sub-key K₂ᵣ:
   W″=K₂ᵣ mod 2³²;
   V′=A|W″.
6. Convert sub-block B according to expression:
   B←R*_{64/96}^{(V″)}(B).
7. Convert sub-block A according to expression:
   A←A⊕K₂ᵣ.
8. Swap sub-blocks A and B.
9. If r=10, then go to step 11.
10. Increment r←r+1 and go to step 2.
11. STOP.

The respective decryption algorithm is as follows:
1. Set the counter r=1.
2. Convert sub-block B according to expression:
   B←B⊕K₂ᵣ₋₁.
3. Generate controlling vector V′ performing calculations:
   W′=K₂₂₋₂ᵣ mod 2³²;
   V′=B|W′,
   where “|” denotes a concatenation operation.
4. Convert sub-block A according to expression:
   A←R*_{64/96}^{(V′)}(A).
5. Generate controlling vector V″ depending on the sub-block A and sub-key K_{21-r;}
   W″=K₂₁₋ᵣ mod 2³²;
   V′=A|W″.
6. Convert sub-block B according to the expression:
   B←R*_{64/96}^{(V″)(}B).
7. Convert sub-block A according to the expression:
   A←A⊕K₂₁₋ᵣ.
8. Swap sub-blocks A and B.
9. If r=10, then go to step 11.
10. Increment r←r+1 and go to step 2.
11. STOP.

Using the P*_{64/96} controlled CSPN-based involution instead of the R*_{64/96} controlled CSPN-based involution we get another implementation example of the disclosed method in which controlled permutational involutions are used.

### EXAMPLE 4

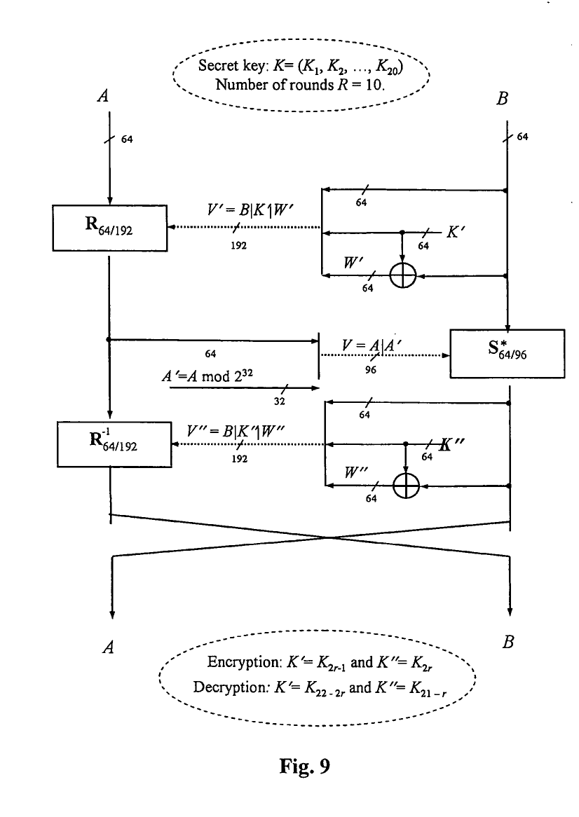

Example 4 uses the secret key represented as the set of the following 64-bit sub-keys: K₁, K₂, . . . , K₂₀. This example is illustrated in FIG. 9. Example 4 describes the following encryption algorithm implementing the declared method:
1. Set the counter r=1.
2. Generate controlling vector V′ performing calculations:
   W′=B⊕K₂ᵣ₋₁;
   V′=B|K₂ᵣ₋₁|W′.
3. Convert sub-block A according to expression:
   A←R_{64/192}^{(V′)}(A).
4. Generate controlling vector V depending on the sub-block A:
   A′=A mod 2³²;
   V=A|A′.
5. Convert sub-block B according to the expression:
   B←S*_{64/96}^{(V)}(B).
6. Generate controlling vector V″ performing calculations:
   W″=B⊕K₂ᵣ;
   V″=B|K₂ᵣ|W″.
7. Convert sub-block A according to expression:
   A←R⁻¹_{64/192}^{(V′)}(A).
8. Swap sub-blocks A and B.
9. If r=10, then go to step 11.
10. Increment r←r+1 and go to step 2.
11. STOP.

The respective decryption algorithm is the following one:
1. Set the counter r=1.
2. Generate controlling vector V′ performing calculations:
   W′=B⊕K₂₂₋₂ᵣ;
   V′=B|K₂₂₋₂ᵣ|W′.
3. Convert sub-block A according to the expression:
   A←R_{64/192}^{(V′)}(A).
4. Generate controlling vector V depending on the sub-block A:
   A′=A mod 2³²;
   V=A|A′.
5. Convert sub-block B according to the expression:
   B←S*_{64/196}^{(V)}(B).
6. Generate controlling vector V″ performing calculations:
   W″=B⊕K₂₁₋ᵣ;
7. Convert sub-block A according to the expression:
   A←R⁻¹_{64/192}^{(V′)}(A).
8. Swap sub-blocks A and B.
9. If r=10, then go to step 11.
10. Increment r←r+1 and go to step 2.
11. STOP.

### EXAMPLE 5

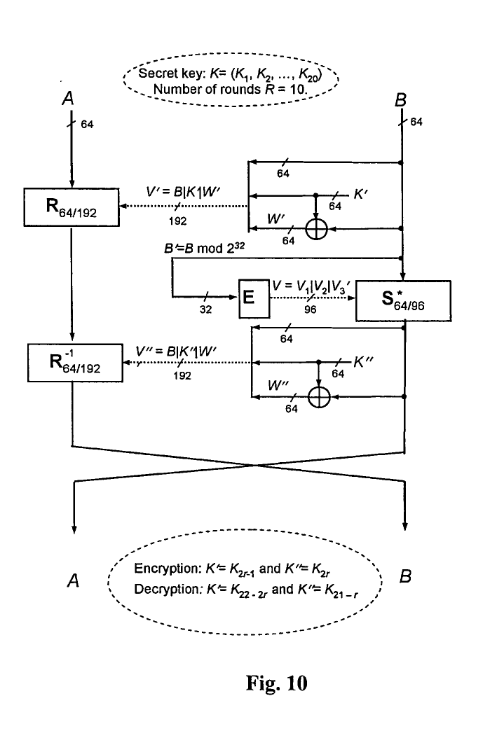

Example 5 uses the secret key represented as the set of the following 64-bit sub-keys: K₁, K₂, . . . , K₂₀. This example is illustrated in FIG. 10. Example 5 describes the following encryption algorithm implementing the disclosed method:
1. Set the counter r=1.
2. Generate controlling vectors V′ and V performing calculations:
   W′=B⊕K₂ᵣ₋₁; V′=B|K₂ᵣ₋₁|W′;
   V₁=B mod 2³²; V₂=V<<<6; V₃=V₁<<<12; V₁=V₁|V₂|V₃.
3. Simultaneously convert sub-blocks A with the direct controlled CSPN-based operation R_{64/192} and sub-blocks B with the controlled CSPN-based involution according to the expressions:
   A←R_{64/192}^{(V′)}(A); B←S*_{64/96}^{(V)}(B).
4. Generate controlling vector V″ performing calculations:
   W″=B⊕K₂ᵣ; V″=B|K₂ᵣ|W″.
5. Convert sub-block A with the inverse controlled CSPN-based operation R⁻¹_{164/192} according to the expression:
   A←R⁻¹_{64/192}^{(V′)}(A).
6. Swap sub-blocks A and B.
7. If r=10, then go to step 9.
8. Increment r←r+1 and go to step 2.
9. STOP.

The corresponding decryption algorithm is the same except for the sub-key K_{22-2r being used at step} 2 instead of K₂ᵣ₋₁ and the sub-key K₂₁₋₂ᵣ being used at step 4 instead of K₂ᵣ.

By using the P*_{64/96} controlled CSPN-based involution instead of the S*_{64/96} involution we get another implementation example of the disclosed method in which the controlled permutational involutions are used.

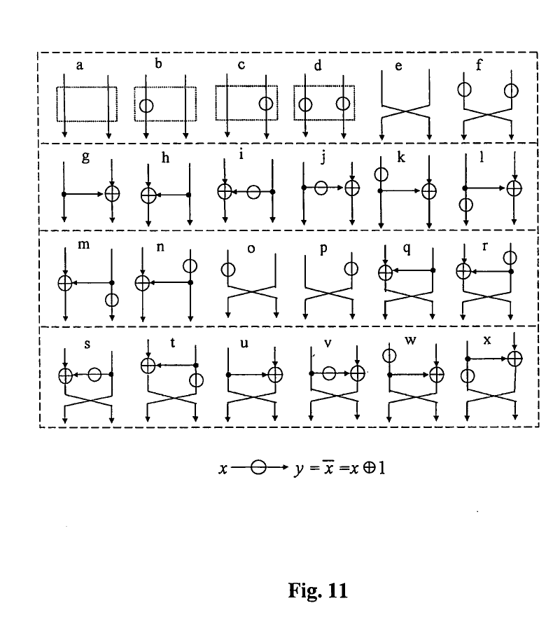

In table 2 and FIG. 11 a number of different examples of controlled elements are shown, that are main building blocks for constructing different CSPN that can be used to perform CSPN-based controlled operations and CSPN-based controlled involutions. An important class of the controlled elements corresponds to the controlled elements F_{2/2} with two-bit input, two-bit output, and two-bit controlling input. The CSPN constructed using the F_{2/2} controlled elements provides more efficient Field Programmable Gate Array (FPGA) implementation of the disclosed encryption method. Indeed, the implementation of the F_{2/1} elements uses only 50% of the resources of two standard cells of a FPGA device. The FPGA implementation of the F_{2/2} element controlled with two controlling bits v₁ and v₂ also require the use of two cells, however while implementing the F_{2/2} element 100% of the resources of two standard cells is used. Elements F_{2/2} can be described as a pair of Boolean functions with four variables, or as a set of four 2×2 substitutions called modifications F_{2/2}⁽⁰⁰⁾, F_{2/2}⁽⁰¹⁾, F_{2/2}⁽¹⁰⁾ and F_{2/2}⁽¹¹⁾. All possible variants of the 2×2 substitutions designated with small letters a, b, c, . . . ,x, are presented in FIG. 11. Selection of four different 2×2 substitutions as four modifications F_{2/2}⁽⁰⁰⁾, F_{2/2}⁽⁰¹⁾, F_{2/2}⁽¹⁰⁾ and F_{2/2}⁽¹¹⁾ defines some controlled element F_{2/2}. Table 2 presents examples of F_{2/2} controlled elements described as sets (F_{2/2}⁽⁰⁰⁾, F_{2/2}⁽⁰¹⁾, F_{2/2}⁽¹⁰⁾, F_{2/2}⁽¹¹⁾).

TABLE 2

| # | Set of modifications |
|---|---|
| 1 | (e, i, j, f) |
| 2 | (e, g, h, f) |
| 3 | (e, i, j, o); |
| 4 | (e, i, j, p); |
| 5 | (f, h, g, e); |
| 6 | (i, f, p, g); |
| 7 | (p, j, i, f) |
| 8 | (h, e, f, j); |
| 9 | (o, g, h, e); |
| 10 | (e, i, g, f); |
| 11 | (h, e, o, g) |
| 12 | (p, h, g, f) |
| 13 | (h, e, f, g) |
| 14 | (e, h, o, j); |
| 15 | (h, p, j, e); |

Alternatively the F_{2/2} controlled elements can be described as a pair of Boolean functions in four variables. This description shows that CSPN based on elements F_{2/2} has a higher non-linearity, since the Boolean functions in four variables have higher non-linearity than Boolean functions in three variables. Therefore CSPN constructed using F_{2/2} elements provides more efficient cryptographic operation than CSPN constructed using F_{2/1} and requires the use of the same FPGA hardware implementation resources. Table 3 shows three examples of the F_{2/2} controlled elements described as a pair of Boolean functions in four variables y₁=f₁(x₁,x₂,v₁,v₂) and y₂=f₂(x₁,x₂,v₁,v₂).

TABLE 3

| # | Pair of Boolean functions describing outputs of the F_{2/2} element |
|---|---|
| 1 | y₁ = v₁v₂x₁ ⊕ v₂x₂ ⊕ v₁x₁ ⊕ v₂x₁ ⊕ x₂ ⊕ v₁; |
| | y₂ = v₁v₂x₂ ⊕ v₁x₁ ⊕ v₂x₂ ⊕ v₁x₁ ⊕ x₁ ⊕ v₂; |
| 2 | y₁ = v₁v₂x₁ ⊕ v₁x₁ ⊕ v₂x₁ ⊕ v₂x₂ ⊕ x₁; |
| | y₂ = v₁v₂x₂ ⊕ v₁x₁ ⊕ v₁x₂ ⊕ v₁v₂ ⊕ v₂x₁ ⊕ x₂ ⊕ v₂; |
| 3 | y₁ = v₁v₂x₂ ⊕ v₁v₂ ⊕ v₁x₁ ⊕ v₂x₁ ⊕ v₂ ⊕ x₁ ⊕ x₂; |
| | y₂ = v₁v₂x₁ ⊕ v₁x₁ ⊕ v₁x₂ ⊕ v₂x₁ ⊕ v₂x₂ ⊕ v₂ ⊕ x₂; |

Table 4 shows examples of F_{2/1} controlled elements described as sets of two modifications (F_{2/1}⁽⁰⁾,F_{2/1}⁽¹⁾).

TABLE 4

| | R_{2/1}-type elements |
|---|---|
| # | (involutions) |
| 1 | (e, i) |
| 2 | (e, g) |
| 3 | (j, f); |
| 4 | (i, f); |
| 5 | (f, g); |
| # | S_{2/1}-type elements |
| 6 | (i, g); |
| 7 | (h, j) |
| 8 | (h, g); |
| 9 | (g, n); |
| 10 | (u, q); |
| # | R_{2/1}-type elements |
| 11 | (r, a) |
| 12 | (x, d) |
| 13 | (j, p) |
| 14 | (o, l); |
| 15 | (p, k); |

Trying all possible variants of the F_{2/1} and F_{2/2} elements, it has been concluded that there exist 192 different controlled elements of the F_{2/1}-type and more than 2208 elements of the F_{2/2}-type suitable for use in the design of highly non-linear controlled CSPN-based involutions that can be efficiently used in the disclosed method.

The above examples show that the proposed method for cryptographic transformations of binary data blocks is technically feasible and is able to solve the problem that has been presented.

The claimed method may be realized in a ciphering and/or deciphering device, for example, in a specialized cryptographic processor. Due to the efficient method, high ciphering rates, in the order of 1 to 10 Gbit/s can be achieved. This is e.g. sufficient for ciphering of real time data transmitted over high speed fiber optic communication channels. Therefore the present invention also provides for a communications network allowing ciphering and/or deciphering by performing a cryptographic transformation of binary data blocks according to said method, and in particular a terminal in such a communication network.

Furthermore, the efficient method also allows a high degree of ciphering with low energy consumption. This feature is especially interesting in radio communications networks and in particular for mobile terminals.

1. A method for cryptographic transformation of a binary data block comprising the steps:
splitting said data block into N≧2 sub-blocks,
alternately converting said sub-blocks by operations implemented with a controlled substitution-permutation network (CSPN), and
performing a controlled CSPN-based involution on at least the i-th sub-block, where i=1, 2, . . . ,N.

2. A method according to claim 1, wherein the controlled CSPN-based involution is a controlled permutational involution.

3. A method according to claim 1, wherein the controlled CSPN-based involution is a controlled substitutional involution.

4. A method according to claim 1, wherein N=2 and the first sub-block is converted with a direct controlled CSPN-based operation depending on the second sub-block, the second sub-block is converted with the controlled CSPN-based involution depending on the first sub-block, and the first sub-block is converted with the inverse controlled CSPN-based operation depending on the second sub-block.

5. A method according to claim 1, wherein N=2 and the first and the second sub-blocks are transformed simultaneously by performing on the first sub-block the direct controlled CSPN-based operation implemented with CSPN depending on the second sub-block and by performing on the second sub-block the controlled CSPN-based involution depending on the second sub-block, and then the first sub-block is converted with the inverse controlled operation implemented with CSPN depending on the second sub-block.

6. Encryption method comprising a cryptographic transformation of binary data blocks according to the method of claim 1.

7. Decryption method comprising a cryptographic transformation of binary data blocks according to the method of claim 1.

8. Method for calculating a hash sum comprising a cryptographic transformation of binary data blocks according to the method of claim 1.

9. Ciphering device arranged to perform a cryptographic transformation of binary data blocks according to the method of claim 1.

10. Deciphering device arranged to perform a cryptographic transformation of binary data blocks according to the method of claim 1.

11. Communications network wherein ciphering and/or deciphering comprises performing a cryptographic transformation of binary data blocks according to the method of claim 1.

12. Terminal in a communications network wherein ciphering and/or deciphering comprises performing a cryptographic transformation of binary data blocks according to the method of claim 1.
